(19) United States
(12) Patent Application Publication
(10) Pub. No.: US 2009/0148093 A1
(43) Pub. Date: Jun. 11, 2009

(54) ADJUSTABLE ANTIFRICTION BEARING ARRANGEMENT

(75) Inventors: Glenn R. Fahrni, JR., Dalton, OH (US); Wayne D. Barnette, Massillon, OH (US)

Correspondence Address: POLSTER, LIEDER, WOODRUFF & LUCCHESI, 12412 POWERSCOURT DRIVE SUITE 200, ST. LOUIS, MO, 63131-3615, US

(73) Assignee: The Timken Company, Canton, OH (US)

(21) Appl. No.: 12/370,076

(22) Filed: Feb. 12, 2009

Related U.S. Application Data
(63) Continuation-in-part of application No. 11/378,502, filed on Mar. 17, 2006, now Pat. No. 7,503,867.
Application No. 11/378,502 is a continuation-in-part of application No. PCT/US2008/067667, filed on Jun. 20, 2008.
(60) Provisional application No. 60/945,742, filed on Jun. 22, 2007.

(51) Int. Cl. F16C 33/58

(52) U.S. Cl. 384/585

(57) ABSTRACT

A shaft is supported in a housing on the front and rear antifriction bearings that are mounted in opposition. The front bearing has an outer race provided with an external thread that engages an internal thread within the housing. That outer race is fitted with a locking ring that is engaged to turn the race and thereby bring the front and rear bearings to a desired setting. The locking ring has a flange that lies along a radially directed face of the housing, and once the bearings achieve a desired setting, a screw is extended through the flange and into the housing to secure the locking ring and the outer race against rotation.

### CROSS-REFERENCE TO RELATED APPLICATIONS

This application is a continuation-in-part of U.S. patent application Ser. No. 11/378,502 filed Mar. 17, 2006, and International Patent Application PCT/U.S. 2008/067667 filed Jun. 20, 2008, both which are incorporated herein by reference. It derives priority from and otherwise claims the benefit of the foregoing applications as well as U.S. provisional application 60/945,742, filed Jun. 22, 2007.

### STATEMENT REGARDING FEDERALLY SPONSORED RESEARCH

Not applicable.

### BACKGROUND OF THE INVENTION

This invention relates in general to antifriction bearings and, more particularly, to an antifriction bearing having an outer race that is provided with external threads to facilitate adjustment of a bearing system of which the bearing is a component.

Antifriction bearings organized in pairs support shafts in a wide variety of equipment. Typically each bearing has an outer race fitted into a housing, an inner race around a shaft, and rolling elements organized in a single row between the two races. The rolling elements contact the races along raceways that are inclined with respect to the axis of the bearings, and the raceways of each bearing, while being inclined in the same direction, are inclined in the direction opposite to the inclination of the raceways of the other bearing. In other words, the two bearings that support the shaft are mounted in opposition. This enables the bearings to be adjusted against each other between end play, where the bearings have internal clearances, and preload where no internal clearances and good shaft stability exists.

Adjustment is achieved by controlling the axial positions of the races. Indeed, axial displacement of any one of the four races will change the setting of the bearings. Some bearing arrangements control the setting at the outer races—or at least at one of the outer races. And one way to control the axial position of an outer race is to provide it with an external thread that engages an internal thread in the housing. Thus, by rotating the outer race in its threaded seat, one can adjust the setting for the bearings. See U.S. Pat. No. 7,393,141.

Tapered roller bearings represent one type of bearing that lends itself to adjustment. And automotive differentials make ample use of tapered roller bearings. Such bearings support pinion shafts in differentials and also fit around stub shafts on the ends of the carriers that deliver torque to the axle shafts. In the forward axles of tandem axle arrangements they support the input shafts, among other shafts. As to any one of these shafts, one bearing is adjusted against another to control the setting of the two bearings.

### DESCRIPTION OF THE SEVERAL VIEWS OF THE DRAWINGS

FIG. 1 is a fragmentary sectional view showing a shaft supported in a housing on bearings including a front bearing constructed in accordance with and embodying the present invention;

FIG. 2 is an enlarged sectional view of the front bearing and showing a locking ring that secures its threaded cup against rotation;

FIG. 2A is an enlarged fragmentary sectional view of the portion of the front bearing enclosed within the ellipse in FIG. 2;

FIG. 3 is a fragmentary sectional view taken along line 3-3 of FIG. 2;

FIG. 4 is an exploded perspective view showing the housing and the threaded cup and locking ring of the front bearing that is fitted to the housing;

FIG. 5 is a sectional view of an alternative housing and bearing arrangement, including a front bearing having a threaded cup;

FIG. 6 is a fragmentary sectional view showing the cup and locking ring of the front bearing;

FIG. 7 is an end view of the locking ring for the front bearing;

FIG. 8 is a perspective view of the cup and an alternative locking ring for the front bearing of FIG. 5;

FIG. 9 is an end view of the cup and the alternative locking ring for the front bearing of FIG. 5;

FIG. 10 is a sectional view of the cup and locking ring taken along line 10-10 of FIG. 9; and

FIG. 11 is a perspective view of the housing of FIG. 5 modified for the alternative locking ring of FIGS. 8-10.

### DETAILED DESCRIPTION

Referring now to the drawings, a bearing system A (FIG. 1) supports a shaft 2 in a housing 4, enabling the shaft 2 to rotate about an axis X. While the particular bearing system A illustrated forms part of an axle center in a forward axle for an automotive vehicle having tandem axles, it could be used in other equipment as well to enable a shaft to rotate in a housing with considerable stability or to enable the housing to rotate relative to the shaft, again with stability. The bearing system A includes front and rear bearings 6 and 8, respectively, that are capable of transferring radial loads as well as thrust loads between the shaft 2 and housing 4. Each bearing 6 and 8 is preferably a single row tapered roller bearing, but other types of bearings having the capacity to transfer radial and thrust loads will suffice. The two bearings 6 and 8 are mounted in opposition in the direct configuration and are adjusted to a desired setting which may be end play, in which clearances exist in the bearings 6 and 8, or preload, which is characterized by the absence of clearances and greater stability.

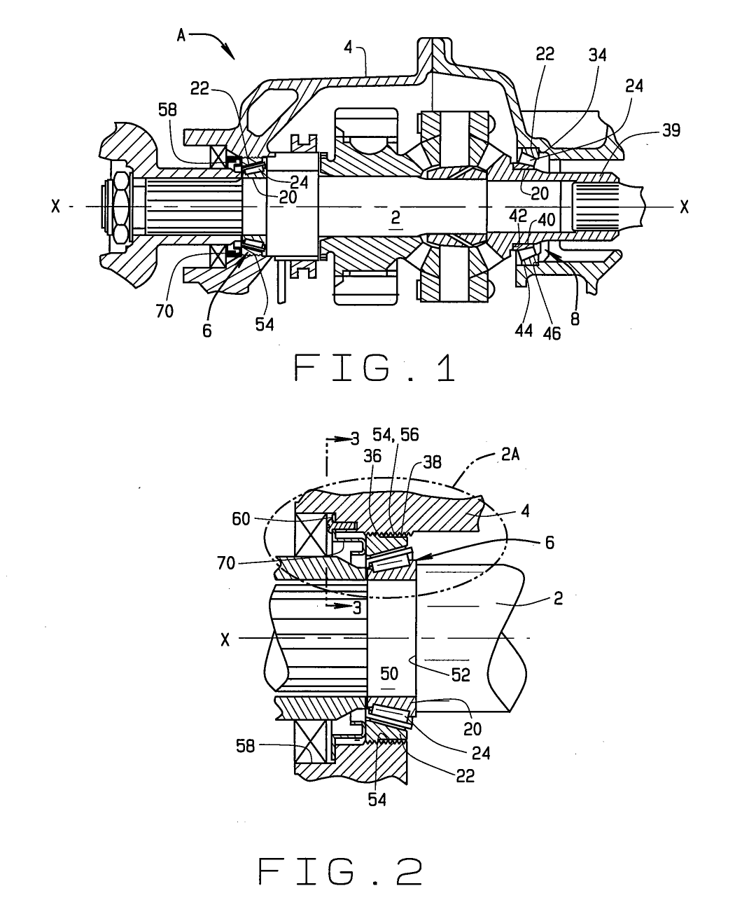

Each bearing 6 and 8 includes (FIGS. 2 & 2A) an inner race in the form of a cone 20, an outer race in the form of a cup 22 that surrounds the cone 20, and rolling elements in the form of tapered rollers 24 located in a single row between the cone 20 and cup 22. The cone 20 has a tapered raceway 26 that faces outwardly away from the axis X. Its large end lies along a thrust rib 28 that leads out to a back face 30 that is perpendicular to the axis X and forms one end of the cone 20. The cup 22 has a tapered raceway 32 that faces inwardly toward the tapered raceway 26 on the cone 20. At the small end of the raceway 32 the cup 22 has a large end face 34 that is also perpendicular to the axis X. The bearings 6 and 8 are mounted in opposition in the direct configuration, that is with the large ends of the rollers 24 for the bearing 6 facing the large ends of the rollers 24 for the bearing 8 (FIG. 1).

The cup 22 of the front bearing 6 differs from the cup 22 of the rear bearing 8 in that along its periphery it has (FIGS. 2A & 4) an external thread 36 that leads away from the back face 34 and a cylindrical surface 38 for the remainder of the periphery. The external thread 36 occupies between 33% and 50% of the length of the cup 22. Where the cup 22 is case carburized and hardened along its surfaces, the thread 36 may be cut through the hard surface (“hard turned”), in that thread-cutting tools now exist for that purpose. On the other hand, where the cup 22 is formed from high carbon steel, it may be induction heated along the raceway 32 only, and then quenched, leaving the peripheral surface capable of being machined with more conventional cutting tools.

The tapered rollers 24 along their tapered side faces contact the raceways 26 and 32 of the cone 20 and cup 22 and along their large end faces bear against the thrust rib 28. Indeed, the thrust rib 28 prevents the rollers 24 from moving up the raceways 26 and 32 and out of the annular space between the cone 20 and cup 22. The rollers 24 are on apex, meaning that the envelopes of their conical surfaces and the envelopes of the raceways 26 and 32 have their apices at a common point along the axis X.

The shaft 2 in the region of the rear bearing 8 (FIG. 1) carries a quill 39 provided with a bearing seat 40 having a shoulder 42 that faces away from the front bearing 6. The cone 20 of the rear bearing 8 fits around the bearing seat 40 with an interference fit and with its back face 30 against the shoulder 42. The housing 4 in the region of the rear bearing 8 has a bearing seat 44 that is presented inwardly toward the bearing seat 40 that encircles the shaft 2 and the cone 20 that is around that bearing seat 40. The seat 44 ends at a shoulder 46. The cup 22 of the rear bearing 8 fits into the bearing seat 44 with an interference fit and with its back face 34 against the shoulder 46. The tapered rollers 24 for the rear bearing 8 are organized in a single row between the cone 20 and cup 22. The arrangement is such that the rear bearing 8 serves to position one end of the shaft 2 radially and to prevent the shaft 2 from displacing axially away from the front bearing 6.

In the region of the front bearing 6, the shaft 2 has (FIGS. 2 & 2A) a bearing seat 50 that ends at a shoulder 52 that faces away from the rear bearing 8. The cone 20 of the front bearing 6 fits over the bearing seat 50 with an interference fit, its back face 30 being against the shoulder 52. The housing 4 in the region of the front bearing 6 has a bore 54 containing an internal thread 56 that is configured to mate with the external thread 36 on cup 22 of the front bearing 6.

The diameter of the crests of the internal thread 56 slightly exceeds the diameter of the cylindrical surface 38 on the cup 22 for the front bearing 6. Preferably those crests are truncated. The bore 54 opens into a counterbore 58 at a shoulder that provides a radially directed face 60.

The cup 22 of the front bearing 6 threads into bore 54 in the housing 4, its external threads 36 engaging the internal thread 56 in the bore 54, while its cylindrical surface 38 lies along the crests of the internal thread 56. The tapered rollers 24 of the front bearing 6 lie between the tapered raceways 26 and 32 of the cone 20 and cup 22 and indeed contact those raceways 26 and 32 along their tapered side faces. The large end faces of the rollers 24 lie along the thrust rib 28. With the large ends of the rollers 24 for the front bearing 6 facing the large ends of the rollers 24 for the rear bearing 8, the bearing 6 takes thrust loads that urge the shaft 2 away from the rear bearing 8 and of course radial loads as well.

By reason of the engaged threads 36 and 56 on the cup 22 and in the housing 4, rotation of the cup 22 for the front bearing 6 will cause the cup 22 to displace axially in the housing 4 and axially relative to the shaft 2. The axial displacement changes the setting for the bearings 6 and 8. The cup 22 is rotated in one direction or the other until the bearings 6 and 8 achieve the correct setting, whether it be end play or preload. It is then secured in the position of rotation that provides the correct setting.

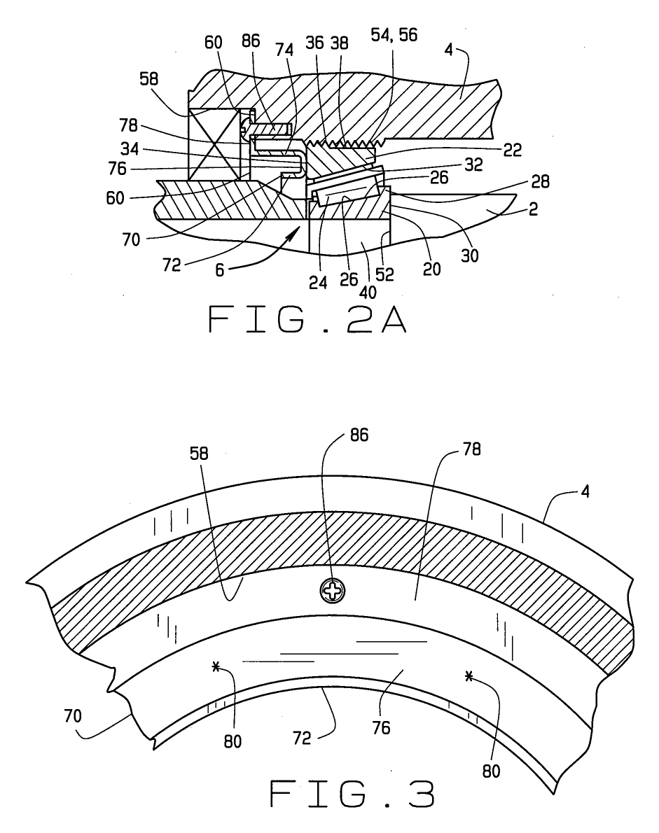

To effect rotation of the cup 22 for the front bearing 6 and securement of it in a desired position, the cup 22 is provided with a locking ring 70 (FIGS. 2-4) that fits against the cup back face 34 to which it is secured, preferably by welding.

More specifically, the ring 70 includes an inner segment 72 and an outer segment 74, both of which are directed axially, and a radially directed web 76 connecting the two axial segments 72 and 74 at their ends closest to the cup 22.

In addition, the locking ring 70 has a flange 78 that is directed radially outwardly from the other end of the outer axial segment 74. The diameter of the inner segment 72 corresponds generally to the diameter of the small end of the raceway 32 for the cup 22. The diameter of the outer segment 74 is essentially that of or slightly less than the external diameter of the cup 22. The web 76 lies against the back face 34 of the cup 22 and covers essentially the entire back face 34. Here the ring 70 is attached to the cup 22, preferably by several projection welds 80, spaced generally equally along the web 76, although mechanical fasteners, such as pins or screws that engage the cup 22 are suitable as well. In any case, the locking ring 70 and cup 22 are coupled such that one cannot be rotated relative to the other.

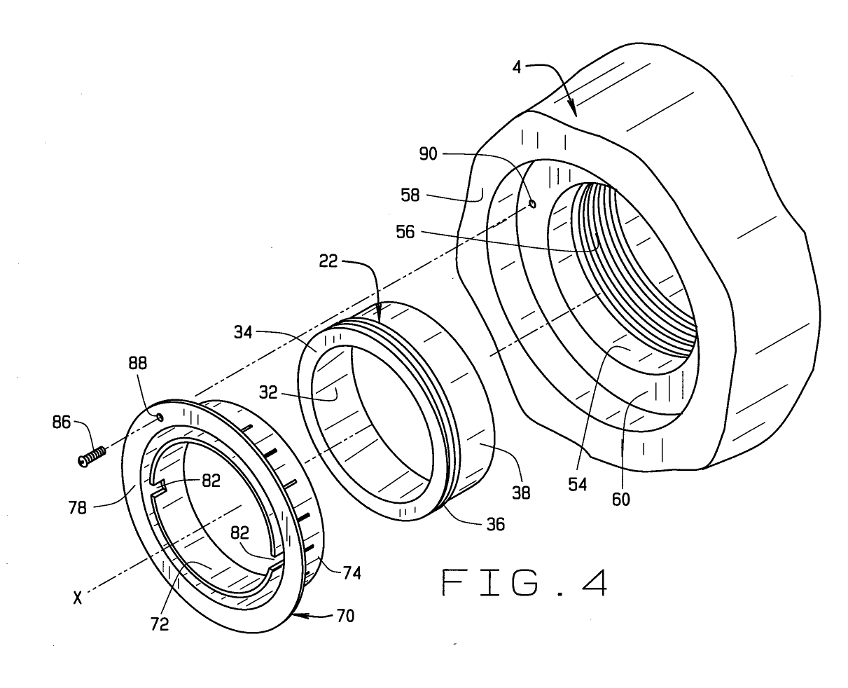

The inner segment 72 provides a surface or formations for engaging and turning the locking ring 70 and of course the cup 22 to which the ring 70 is attached, and this enables the cup 22 to be advanced to a position which provides the correct adjustment for the bearings 6 and 8, that is to say, for the bearing system A. To this end, the inner segment 72 may be provided with notches 82 (FIG. 4) that are capable of receiving projections on an adjusting tool that can rotate the ring 70. U.S. Pat. No. 7,393,141 shows a suitable adjusting tool and is incorporated herein by reference.

The cup 22 of the front bearing 6 along its external surfaces, including its back face 34, is formed from high carbon steel, preferably as a consequence of case carburizing. The locking ring 70, on the other hand, is a stamping formed from low carbon steel, and is thus somewhat malleable. U.S. published patent application U.S. 2006/0243353 A1 discloses a process for welding the low carbon steel of the locking ring 70 to the high carbon steel of the cup 22, either by the projection welds 80 or by a lap seam weld. That patent application is incorporated herein by reference.

The flange 78 of the locking ring 70 projects radially outwardly from the outer axial segment 74 and into the counterbore 58 of the housing 4. There it is presented opposite the housing face 60, but a space exists between the flange 78 and the face 60, so that the flange 78 does not interfere with the axial movement of the cup 22 as it is rotated to adjust the bearings 6 and 8.

To adjust the front bearing 6 against the rear bearing 8 so as to achieve a desired setting, one turns the locking ring 70 on the cup 22 of the front bearing 6, preferably with a tool that engages the inner segment 72 of the ring 70 at the notches 82 in it. The rotation, by reason of the engaged threads 36 and 56 in the bore 54 and on the cup 22, displaces the cup 22 axially, and that of course changes the setting for the bearings 6 and 8. Once the bearings 6 and 8 acquire the correct setting, the cup 22 of the front bearing 6 is secured against further rotation—and further axial displacement—with a screw 86 (FIGS. 2A & 3) that passes through the flange 78 of the locking ring 70 and threads into the housing 4. In this regard, the flange 78, once the bearings 6 and 8 acquire the proper setting, is provided with a hole 88 (FIG. 4) that aligns with a hole 90 that opens out of the face 60 in the housing 4. The two holes 88 and 90 may be formed at the same time with a single drill bit, or the housing 4 may be provided with its hole 90 before the cup 22 for the front bearing 6 is installed in the threaded bore 54. Moreover, the hole 90 may or may not have threads. In any event, the hole 88 in the flange 78 of the locking ring 70 receives the screw 86 that threads into the hole 90 in the housing 4. The head of the screw 86 is run down against the flange 78 and distorts the flange 78, deforming it against the housing face 60 in the region of the screw 86. The screw 86 prevents the locking ring 70 and the cup 72 to which it is attached from rotating. Other types of fasteners may be used in lieu of the screw 86.

Should the hole 90 in the housing 4 be predrilled, the flange 78 may have a circle inscribed upon it at the radius of the hole 90, this to insure that the hole 88 that is later drilled through the flange 78 will align with the hole 90 in the housing 4.

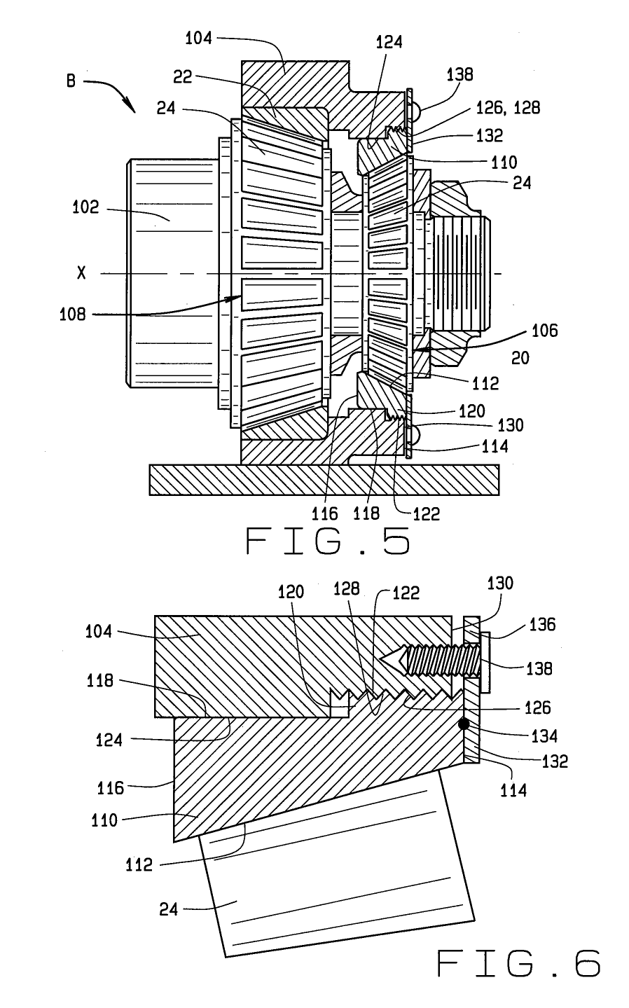

An alternative bearing system B (FIG. 5) supports a shaft 102 in a housing 104 on front and rear tapered roller bearings 106 and 108 that are mounted in the indirect configuration. The rear bearing 108 is conventional and as such has a cone 20, a cup 22, and tapered rollers 24, as does the rear bearing 8 in the bearing system A. The front bearing 106 corresponds closely to the front bearing 6 of the system A, and likewise has a conventional cone 20 and tapered rollers 24. While the front bearing 106 has a. cup 110, it differs slightly from the cup 22 of the front bearing 6. In this regard, the cup 110 (FIG. 6) has a tapered raceway 112 that contacts the tapered side faces of the rollers 24. In addition, it has front and back end faces 114 and 116 between which the raceway 112 extends. Along its periphery it has a cylindrical surface 118 that leads out to the back end face 116 and an annular rib 120 that leads out to the front end face 114. The rib 120 has an external thread 122 cut into it, and it extends the full length of the rib 120. The root diameter of the thread 122 exceeds the diameter of the cylindrical surface 118.

The housing 104 contains a cylindrical bearing seat 124, the diameter of which corresponds to the diameter of the cylindrical surface 118 on the cup 110 such that the cup 110 at its cylindrical surface 118 can fit into the cylindrical seat 124 with enough clearance to enable the cup 110 to rotate in the seat 124, yet not so much as to detract from the stability of the cup 110. Beyond the cylindrical seat 124, the housing 104 has a counterbore 126 provided with an internal thread 128 which is configured to mate with the external thread 122 on the cup 110. The counterbore 126 leads out to an end face 130 on the housing 104.

The cup 110 fits into the housing 104 with its cylindrical surface 118 in the bearing seat 124 of the housing 104 and the external thread 122 on its rib 120 engaged with the internal thread 128 of the housing 104. Thus, the front bearing 106 can be adjusted against the rear bearing 108 to achieve the desired setting for the system B simply by rotating the cup 110 of the front bearing 106. Owing to the engaged threads 122 and 128, the rotation displaces the cup 110 axially.

Even so, the front end face 114 of the cup 110 lies beyond the end face 130 of the housing 104.

To facilitate rotation of the cup 110 so as to adjust the bearings 106 and 108 and to secure it against rotation once the correct selling is achieved, the cup 110 is provided with a locking ring 132 (FIGS. 6 & 7). It takes the form of an annular plate that fits against the front end face 114 of the cup 110, it being attached to the cup 110 at several projection welds 134 so that the ring 132 cannot rotate relative to the cup 110—the two must rotate together. The inner margin of the locking ring 132 generally registers with the large end of the raceway 112. The outer margin lies well beyond the enlarged rib 120, thus providing a flange 136 that lies opposite the end face 130 of the housing 104. The flange 136 contains holes 137.

One may grip ring 132 at its flange 136 to turn it, and once the bearing system B achieves the proper setting, the ring 132—and likewise the cup 110—is secured against further rotation by screws 138 that pass through the holes 137 in the ring 132 and thread into the housing 104. As the screws 138 are turned down, their heads may deflect the flange 136 against the end face 130 at those regions of the flange 136 through which the screws 138 pass.

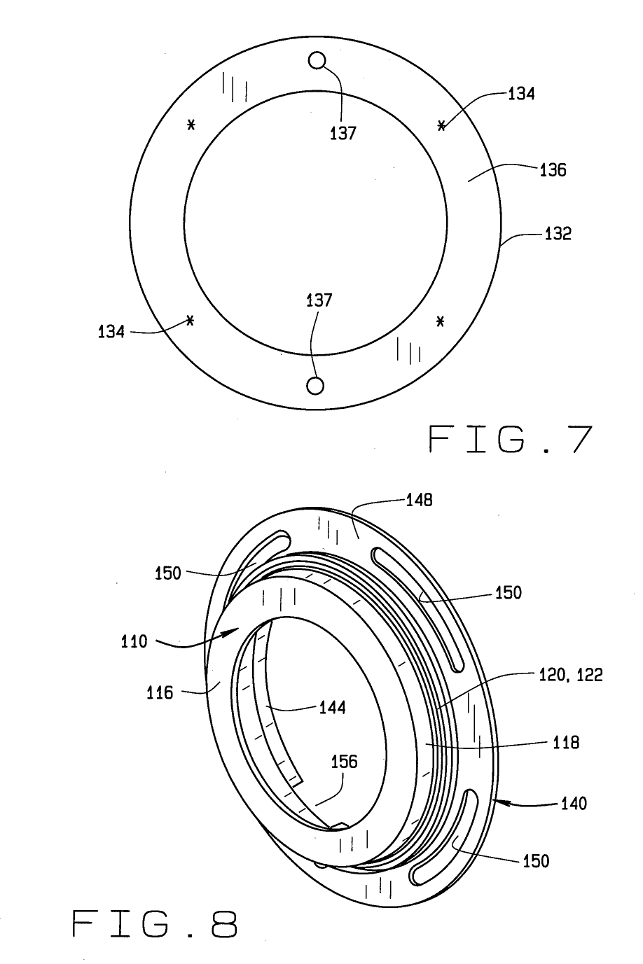

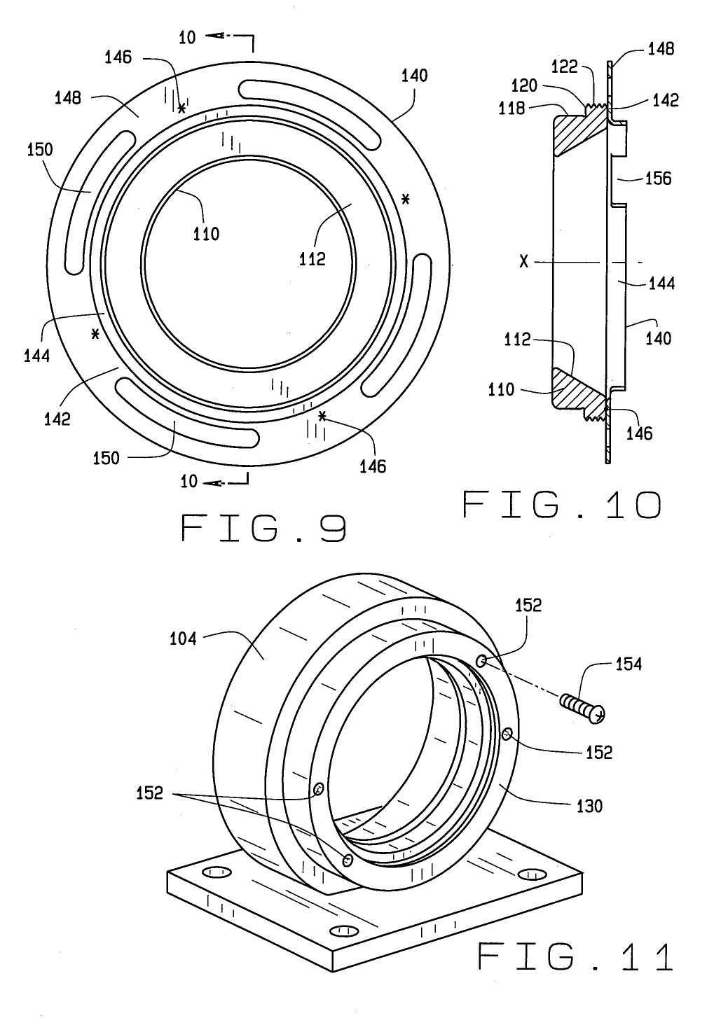

The cup 110 for the front bearing 106 in the system B may be rotated and secured with a modified locking ring 140 (FIGS. 8-10) that requires a minor modification of the housing 104. The locking ring 140, which is a sheet metal stamping formed from low carbon steel, has a radially directed segment 142 and a lip 144 directed axially away from the cup 110 at its inner margin. The radially directed segment 142 abuts the front end face 114 on the cup 110, and here the locking ring 140 is secured firmly to the cup 110 with several projection welds 146. The radial segment 142 projects outwardly beyond the threaded rib 120 on the cup 110 in the provision of a flange 148 that lies opposite the end face 130 of the housing 104, yet is spaced from the face 130. The flange 148 contains four arcuate slots 150 arranged about the axis X at equal circumferential intervals, each subtending about 45°. The end face 130 of the housing 104 is exposed through the slots 150.

The housing 104 contains four threaded holes 152 (FIG. 11) that open out of end face 130, with each being located at the same radius as the arcuate slots 150. The arrangement is such that two holes 152 will always be exposed through two of the arcuate slots 150 located 180° apart, irrespective of the angular position of the locking ring 140 and the cup 110 to which it is attached. The two threaded holes 152 that are exposed receive screws 154 that pass through the two arcuate slots 150 at those holes 152.

The lip 144 has notches 156 or other formations that enable it to be engaged by a tool suitable for rotating the locking ring 140 and the cup 110 to which it is secured.

Thus, by rotating the locking ring 140, with of course the screws 154 removed from the threaded holes 152, one can change the axial position of the cup 110, and with that change the setting of the bearing system B. Once the cup 110 arrives at the angular position that provides the correct setting for the system B, the screws 154 are inserted through the arcuate slots 150 and threaded into the two threaded holes 152 that are exposed. The screws 154 are turned down sufficiently to deform the regions of the flange 148 at which they are located against the end face 130 of the housing 104. Indeed, the screws 154 clamp those regions of the flange 148 against the end face 130 and thereby secure the locking ring 140 and the cup 110 against rotation. This maintains the setting for the bearings 106 and 108.

The bearings 6 and 8 and the bearings 106 and 108 need not be tapered roller bearings. Indeed, any type of bearings that lend themselves to adjustment may be used. Typically such bearings have raceways that are oriented at angles with respect to the axis X. For example, angular contact ball bearings will suffice as substitutes for the bearings 6 and 8 and the bearings 106 and 108. The shaft 2 or 102 may be stationary and the housings 4 or 104 rotatable.

1. An antifriction bearing for facilitating rotation about an axis, said bearing comprising;
an outer race having an outer raceway that is presented inwardly toward the axis and also having an external thread presented outwardly away from the axis;
an inner raceway presented outwardly toward the raceway of the outer race;
rolling elements arranged in a row between and contacting the outer and inner raceways; and
a locking ring attached to the outer race such that the outer race and locking ring cannot be displaced angularly with respect to each other, the locking ring having a flange that is directed generally outwardly beyond the external thread and is provided with an aperture for receiving a fastener that secures the locking ring and outer race against rotation.

2. A bearing according to claim 1 wherein the outer race has an end face and the locking ring is against the end face of the outer race.

3. A bearing according to claim 2 wherein the locking ring has inner and outer axially directed segments and a web connecting the segments; wherein the web is against the end of the outer race and the locking ring is secured to the outer race at the web; wherein the flange extends from the outer segment; and wherein the inner segment is configured for engagement by a tool designed to rotate the locking ring and the outer race.

4. A bearing according to claim 2 wherein the locking ring is secured against the end face of the outer race by a weld.

5. A bearing according to claim 2 wherein the raceways are inclined, with each having a large end and a small end; and wherein the end face of the outer race is at one of the ends of the raceway for the outer race.

6. A bearing according to claim 5 wherein the locking ring is against the end face of the outer race that is at the small end of the raceway for the outer race.

7. A bearing according to claim 5 wherein the locking ring is against the end face of the outer race that is at the large end of the raceway for the outer race.

8. A bearing according to claim 2 wherein the outer race has at its periphery the external thread and also a cylindrical surface; and wherein the diameter of the external thread exceeds the diameter of the cylindrical surface.

9. A bearing according to claim 8 wherein the outer race has two end faces; and wherein the external thread leads out to one of the end faces and the cylindrical surface leads out to the other end face.

10. A bearing according to claim 2 in combination with a housing containing an internal thread and having a face located at a steep angle with respect to the axis, the external thread of the outer race being engaged with the internal thread of the housing and the flange of the locking ring lying opposite the face on the housing.

11. The combination according to claim 10 where at least one fastener extends through the flange of the locking ring and into the housing to secure the locking ring against rotation in the housing.

12. The combination according to claim 11 wherein the apertures in the flange of the locking rings are arcuate slots arranged circumferentially in the flange, and the fasteners extend through two of the slots, with the fasteners being positioned such that the slots will accommodate them for any degree of rotation of the locking ring.

13. The combination according to claim 11 wherein the locking ring includes inner and outer axially directed segments and a web connecting the segments at one end of each segment; wherein the flange is at the other end of the outer segment; and wherein the web is against the end face of the outer race and the locking ring is secured to the outer race at its web.

14. The combination according to claim 11 wherein the locking ring is a generally flat annular plate.

15. The combination according to claim 11 wherein the outer race along its periphery has the external thread and also a cylindrical surface.

16. The combination according to claim 15. wherein the cylindrical surface lies along the internal threads on the housing.

17. The combination according to claim 15 wherein the housing adjacent to its internal thread has a cylindrical bearing seat and the cylindrical surface of the outer race lies within the cylindrical bearing seat.

18. A machine organized about an axis of rotation and comprising:
an outer member having a bore provided with an internal thread, the outer member also having a face located beyond the internal thread at a steep angle with respect to the axis;
an inner member located within the outer member; and
first and second antifriction bearings located between the outer and inner members for enabling one member to rotate relative to the other member about the axis;
the first bearing including an outer raceway carried by the outer member and an inner raceway carried by the inner member and rolling elements located between the raceways, the raceways of the first bearing being inclined in the same direction with respect to the axis, so that the first bearing will transfer thrust loads in one axial direction;
the second bearing including an inner raceway carried by the inner member, an outer race having an outer raceway and an external thread, and rolling elements between the outer and inner raceways, the raceways of the second bearing being inclined in the same direction with respect to the axis and in the direction opposite to the inclination of the raceways of the first bearing so that the second bearing will transfer thrust loads in the opposite axial direction, the external thread of the outer race engaging the internal thread of the outer member so that the axial position of the outer race and. the setting of the bearings can be adjusted by rotating the outer race relative to the outer member, the second bearing further including a locking ring that is attached to the outer race, the locking ring having a flange that is directed outwardly past the threads and lies opposite the face on the housing, and a fastener extended through the flange into the housing for securing the locking ring and outer race against rotation with respect to the housing.

19. A machine according to claim 18 wherein the raceways of the second bearing are conical and the rolling elements are tapered rollers.

20. A machine according to claim 18 wherein the outer member is a housing and the inner member is a shaft that rotates in the housing.
